(19) United States
(12) Patent Application Publication
(10) Pub. No.: US 2024/0253564 A1
(43) Pub. Date: Aug. 1, 2024

(54) DRIVING SUPPORT DEVICE

(71) Applicant: TOYOTA JIDOSHA KABUSHIKI KAISHA, Toyota-shi (JP)

(72) Inventor: Tatsuya ITO, Toyota-shi (JP)

(73) Assignee: TOYOTA JIDOSHA KABUSHIKI KAISHA, Toyota-shi (JP)

(21) Appl. No.: 18/526,176

(22) Filed: Dec. 1, 2023

(30) Foreign Application Priority Data
Jan. 31, 2023 (JP) 2023-012688

(51) Int. Cl. B60R 1/24; B60R 1/26; B60W 30/18; G06V 20/58

(52) U.S. Cl. CPC B60R 1/24; B60R 1/26; B60W 30/18154; G06V 20/584; B60R 2300/607; B60W 2420/403; B60W 2555/60

(57) ABSTRACT

The driving support device includes a display device, a front camera, a traffic light identification unit, a stop position determination unit, a travel control unit, and a display control unit. The display device displays information related to driving support for the vehicle. The front camera captures an image of the front of the vehicle. The traffic light identification unit identifies a traffic light to be obeyed based on the image captured by the front camera. The stop position determination unit determines a stop position such that the traffic light to be obeyed fits within an imaging range of the front camera at an area before a stop position farthest point. The travel control unit controls the vehicle to travel to the stop position. The display control unit causes the display device to display an image including at least the traffic light to be obeyed and recognized by the front camera.

### CROSS-REFERENCE TO RELATED APPLICATION

This application claims priority to Japanese Patent Application No. 2023-012688 filed on Jan. 31, 2023, incorporated herein by reference in its entirety.

### BACKGROUND

### 1. Technical Field

The present disclosure relates to a driving support device.

### 2. Description of Related Art

As a conventional driving support device, for example, a technology described in Japanese Unexamined Patent Application Publication No. 2021-68317 (JP 2021-68317 A) is known. The driving support device described in JP 2021-68317 A performs control based on map information. The driving support device determines a first stop position according to traffic regulations in the lane in which a vehicle travels. The driving support device determines a second stop position closest to a traffic light so as to be able to determine the aspects of the traffic, in a region on the lane in which the vehicle is traveling, based on the image captured by the camera. The driving support device sets one of the first stop position and the second stop position that is farther from the traffic light as a target stop position. The driving support device stops the vehicle at the target stop position.

When the vehicle turns right at an intersection due to autonomous driving, and the vehicle stops in front of the position where the it should stop during manual driving in order to wait for a right turn in the intersection, the driver of the vehicle may feel a sense of incongruity in the stop position.

### SUMMARY

An object of the present disclosure is to provide a driving support device that can suppress the driver of a vehicle from feeling a sense of incongruity when the vehicle stops in an intersection.

One aspect of the present disclosure is a driving support device that supports driving of a vehicle for left-hand traffic when the vehicle turns right at an intersection. The driving support device includes: a display unit that displays information related to driving support of the vehicle; a front imaging unit that takes an image of an area in front of the vehicle; a traffic light identifying unit that identifies, based on the image taken by the front imaging unit, a traffic light to be obeyed and installed at the intersection; a stop position determination unit that determines a stop position such that, when a content of an aspect of the traffic light to be obeyed and identified by the traffic light identifying unit indicates a state in which a right turn is permitted, the traffic light to be obeyed fits within an imaging range of the front imaging unit at an area before a stop position farthest point for waiting for the right turn in the intersection; a travel control unit that controls the vehicle to travel to the stop position determined by the stop position determination unit; and a display control unit that causes the display unit to display, when the vehicle stops at the stop position, an image including at least the traffic light to be obeyed and recognized by the front imaging unit.

The display control unit may cause the display unit to highlight the traffic light to be obeyed.

The display control unit may cause the display unit to display the image of the area in front of the vehicle, the image being taken and obtained by the front imaging unit.

The driving support device may further include: a rear imaging unit that takes an image of an area behind the vehicle; and a side imaging unit that takes an image of an area on a lateral side of the vehicle. The display control unit may cause the display unit to display a bird's-eye view image together with the imaging range of the front imaging unit, the bird's-eye view image being obtained by synthesizing the images taken by the front imaging unit, the rear imaging unit, and the side imaging unit.

Another aspect of the present disclosure is a driving support device that supports driving of a vehicle for right-hand traffic when the vehicle turns left at an intersection. The driving support device includes: a display unit that displays information related to driving support of the vehicle; a front imaging unit that takes an image of an area in front of the vehicle; a traffic light identifying unit that identifies, based on the image taken by the front imaging unit, a traffic light to be obeyed and installed at the intersection; a stop position determination unit that determines a stop position such that, when a content of an aspect of the traffic light to be obeyed and identified by the traffic light identifying unit indicates a state in which a left turn is permitted, the traffic light to be obeyed fits within an imaging range of the front imaging unit at an area before a stop position farthest point for waiting for the left turn in the intersection; a travel control unit that controls the vehicle to travel to the stop position determined by the stop position determination unit; and a display control unit that causes the display unit to display, when the vehicle stops at the stop position, an image including at least the traffic light to be obeyed and recognized by the front imaging unit.

According to this disclosure, it is possible to suppress the driver of a vehicle from feeling a sense of incongruity when the vehicle stops in an intersection.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram showing the configuration of a driving assistance device according to one embodiment of the present disclosure;

FIG. 2 is a flowchart showing the procedure of driving support processing executed by the ECU;

FIG. 3 is a flowchart showing the procedure of driving assistance processing executed by the ECU;

FIG. 4 is a bird's-eye view showing a state in which the own vehicle is stopped waiting for a right turn;

FIG. 5A is a diagram showing an example of an image displayed on the display;

FIG. 5B is a diagram showing an example of an image displayed on the display; and

FIG. 6A is a bird's-eye view showing a comparative example in which the own vehicle is stopped waiting for a right turn;

FIG. 6B is a bird's-eye view showing a comparative example in which the own vehicle is stopped waiting for a right turn; and

FIG. 6C is a bird's-eye view showing a comparative example in which the host vehicle is stopped waiting for a right turn.

### DETAILED DESCRIPTION OF EMBODIMENTS

Hereinafter, embodiments of the present disclosure will be described in detail with reference to the drawings. In the drawings, the same or equivalent elements are denoted by the same reference numerals, and overlapping descriptions are omitted.

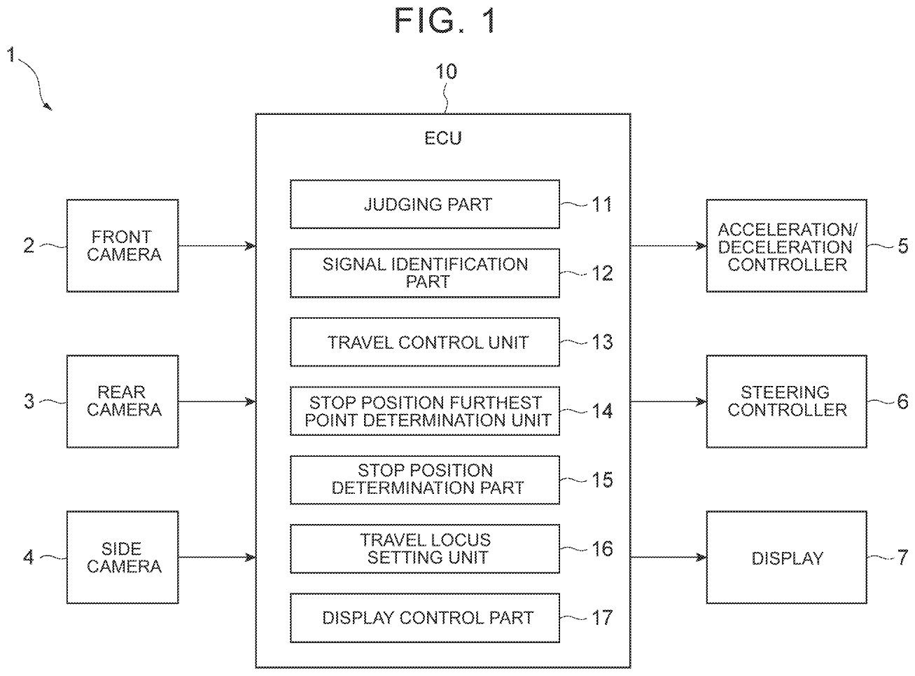

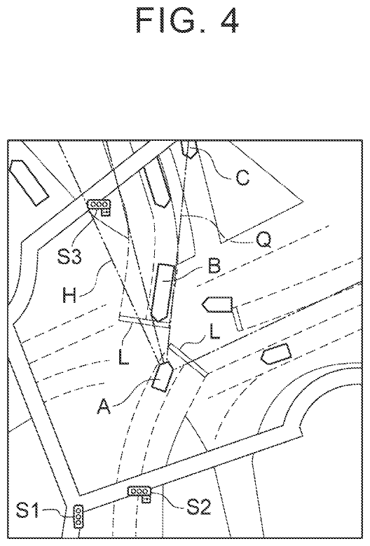

FIG. 1 is a block diagram showing the configuration of a driving assistance device according to one embodiment of the present disclosure. In FIG. 1, a driving support device 1 of the present embodiment is mounted on a vehicle A (see FIG. 4) having an automatic driving function. The driving support device 1 assists the vehicle A in driving on the left when the vehicle A makes a right turn at an intersection with a traffic light.

The driving support device 1 includes a front camera 2, a rear camera 3, a side camera 4, an acceleration/deceleration control device 5, a steering control device 6, a display 7, and an Electronic Control Unit (ECU) 10.

The front camera 2 is a front imaging unit that images the front of the vehicle A. The rear camera 3 is a rear imaging unit that images the rear of the vehicle A. The side camera 4 is a side imaging unit that captures an image of the side of the vehicle A. The front camera 2, the rear camera 3, and the side camera 4 are cameras for recognizing traffic lights and road paint such as white lines drawn on the road.

The acceleration/deceleration control device 5 controls the engine and brakes of the vehicle A so that the vehicle A accelerates and decelerates. The steering control device 6 controls the steering of the vehicle A so that the vehicle A is steered.

The display 7 is a display unit that displays information related to driving support for the vehicle A. As the display 7, for example, an in-vehicle display such as a multimedia display, a center display, and a meter is used. Alternatively, a head-up display or the like may be used as the display 7.

The ECU 10 is composed of a CPU, a RAM, a ROM, an input/output interface, and the like. The ECU 10 includes a determination unit 11, a traffic signal identification unit 12, a travel control unit 13, a stop position furthest point determination unit 14, a stop position determination unit 15, a travel locus setting unit 16, and a display control unit 17.

Based on the image captured by the front camera 2, the determination unit 11 determines the display content of the traffic light installed at the intersection, the presence or absence of an obstacle entering the course of the vehicle A, and the presence or absence of the guideline for the stop position drawn on the road at the intersection.

The traffic signal identification unit 12 identifies a traffic signal installed at the intersection to be obeyed based on the image captured by the front camera 2. The traffic signal to be observed is the traffic signal that the vehicle A should follow at the intersection.

The travel control unit 13 controls the acceleration/deceleration control device 5 and the steering control device 6 so that the vehicle A turns right at the intersection according to the determination result of the determination unit 11. The travel control unit 13 controls the acceleration/deceleration control device 5 and the steering control device 6 so that the vehicle A travels to a stop position (described later) when the display content of the traffic signal to be obeyed indicates that a right turn is permitted.

The stop position furthest point determination unit 14 determines the farthest stop position for waiting for a right turn in an intersection based on the image captured by the front camera 2. The farthest point of the stop position is the farthest (farthermost) point that can be a stop position for the vehicle A to wait for an oncoming vehicle to pass in the intersection when the vehicle A turns right at the intersection.

The stop position determination unit 15 determines such a stop position that the traffic signal to be observed is within the imaging range of the front camera 2 before the farthest point of the stop position when the display content of the traffic signal to be observed is in a state in which a right turn is permitted.

The travel locus setting unit 16 sets the travel locus of the vehicle A up to the stop position determined by the stop position determination unit 15. The travel locus setting unit 16 sets a travel locus such that the vehicle A does not run off the lane.

The display control unit 17 causes the display 7 to display an image including at least the obeying traffic signal recognized by the front camera 2 when the vehicle A stops at the stop position determined by the stop position determination unit 15.

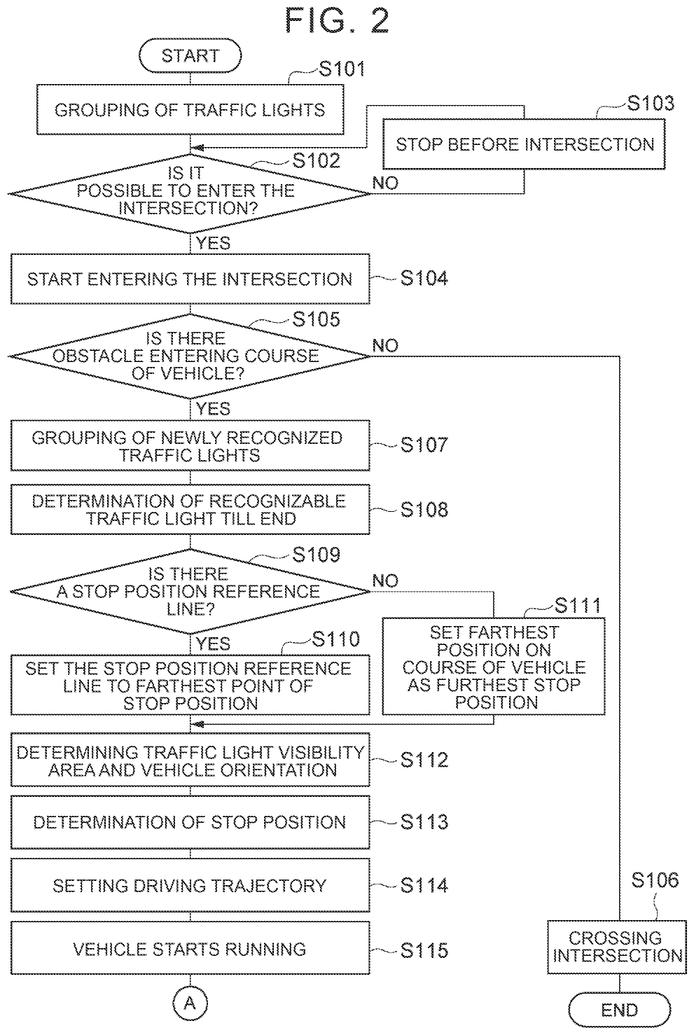

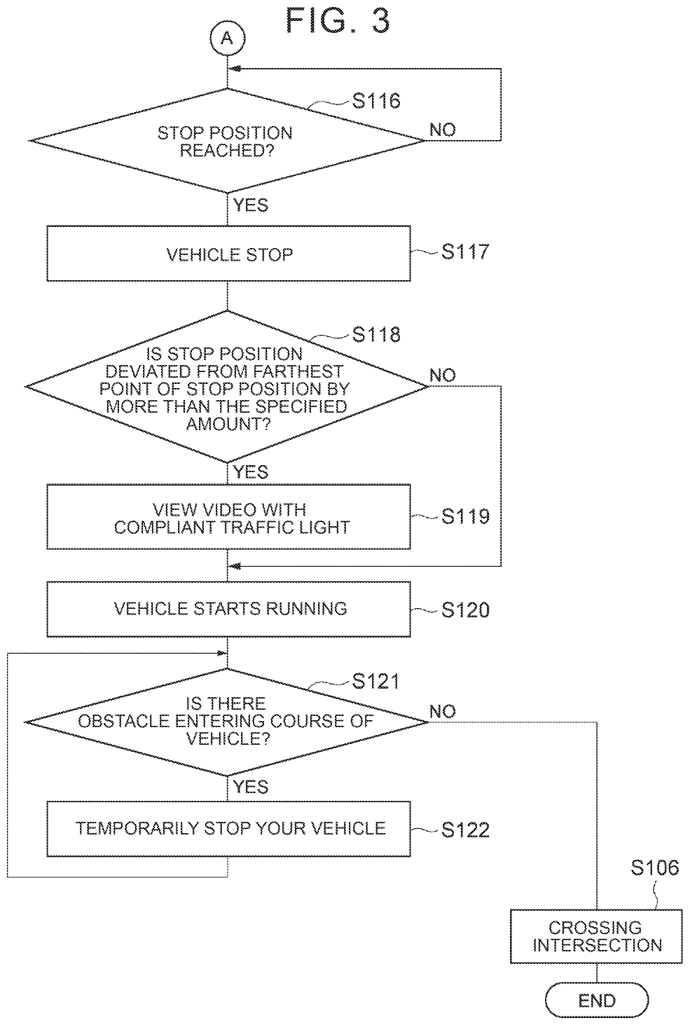

FIGS. 2 and 3 are flowchart showing the procedure of the driving support process executed by the ECU 10. Note that this processing is executed when self-vehicle A turns right at an intersection with a traffic light by automatic driving. At the start of execution of this process, the vehicle A is traveling in the right turn lane before the intersection.

In FIG. 2, the ECU 10 first groups the traffic lights placed in front of the vehicle A based on the captured image of the front camera 2, and selects the traffic lights to follow (step S101). At this time, traffic lights having the same indication content may be grouped, or traffic lights other than red lights may be grouped. If the right-turn lane has a traffic signal dedicated to right-turn vehicles, that traffic signal is selected.

Subsequently, the ECU 10 determines whether or not the traffic light to be followed is green based on the image captured by the front camera 2, thereby determining whether or not the vehicle A can enter the intersection (step S102). For example, at the intersection shown in FIG. 4, it is determined whether the right turn arrow of the traffic light S3 is green. When the ECU 10 determines that the vehicle A cannot enter the intersection, it controls the acceleration/deceleration control device 5 so that the vehicle A stops before the intersection (step S103).

When the ECU 10 determines that the vehicle A can enter the intersection, the ECU 10 controls the acceleration/deceleration control device 5 and the steering control device 6 so that the vehicle A enters the intersection (step S104). At this time, the steering control device 6 is controlled so that the vehicle A travels on the right side (inside course) of the right-turn lane in order to ensure visibility of the oncoming vehicle and the traffic light by the front camera 2.

Subsequently, the ECU 10 determines whether there is an obstacle entering the course of the vehicle A based on the image captured by the front camera 2 (step S105). Obstacles include oncoming straight-ahead vehicles, oncoming left-turning vehicles, two-wheeled vehicles, bicycles, pedestrians, and the like. When the ECU 10 determines that there is no obstacle entering the course of the vehicle A, it controls the acceleration/deceleration control device 5 and the steering control device 6 so that the vehicle A turns right and passes through the intersection (step S106).

When the ECU 10 determines that there is an obstacle entering the path of the vehicle A, the ECU 10 groups traffic lights newly recognized after the vehicle A entered the intersection based on the image captured by the front camera 2 (step S107).

Then, the ECU 10 determines a traffic signal that can be recognized to the end by the front camera 2 in the right-turn lane, among the traffic lights grouped in steps S101 and S107, as a traffic signal to be complied with (step S108). For example, as shown in FIG. 4, when three traffic lights S1 to S3 are installed at an intersection, the traffic light S3 located at the farthest side in the intersection is determined as the signal to be obeyed.

Subsequently, the ECU 10 determines whether or not there is a stop position reference line at the intersection based on the image captured by the front camera 2 (step S109). The stop position reference line is a line that serves as a guideline for a right-turning leading vehicle to temporarily stop when waiting for a right turn, and is drawn on the road in the center of an intersection.

When the ECU 10 determines that the stop position reference line exists at the intersection, the ECU 10 sets the stop position reference line to the farthest stop position (step S110). For example, at the intersection shown in FIG. 4, the stop position reference line L exists, so the stop position reference line L is set at the farthest point of the stop position.

When the ECU 10 determines that the stop position reference line does not exist at the intersection, it sets the farthest point on the route of the vehicle A that does not block the course of the oncoming straight-ahead vehicle and the oncoming right-turning vehicle as the farthest stop position point (step S111).

After executing step S110 or step S111, based on the angle of view, installation position, and orientation of the front camera 2, the ECU 10 determines an area (visual recognition area) in which the traffic light to be observed can be visually recognized by the front camera 2 and the vehicle A direction (step S112). At this time, the visual recognition area of the traffic signal to be observed and the orientation of the vehicle A are determined in consideration of the possibility of being blocked by an oncoming right-turning vehicle or the like.

Then, the ECU 10 determines a stop position before the farthest point of the stop position within the visual recognition area of the traffic signal to be complied with (step S113). At this time, as shown in FIG. 4, the stop position is determined in consideration of the blind spot Q of the oncoming right-turning vehicle B so that the front camera 2 can easily recognize the oncoming straight-ahead vehicle C.

Subsequently, the ECU 10 sets the travel locus of the vehicle A up to the stop position determined in step S113 (step S114). At this time, the travel locus is set within a range in which the vehicle A travels within the right-turn lane.

Subsequently, the ECU 10 controls the acceleration/deceleration control device 5 and the steering control device 6 so that the vehicle A travels along the travel locus (step S115). At this time, the ECU 10 maycorrect (finely adjust) the stop position of the vehicle A based on the position of the traffic light to be observed in the captured image of the front camera 2 and the positional relationship with the oncoming vehicle.

In FIG. 3, after executing step S115, the ECU 10 determines whether or not the vehicle A has reached the stop position based on the image captured by the front camera 2 (step S116). When the ECU 10 determines that the vehicle A has reached the stop position, the ECU 10 controls the acceleration/deceleration control device 5 and the steering control device 6 so that the vehicle A stops in the direction determined in step S112 (procedure S117).

At this time, as shown in FIG. 4, the traffic light S3 to be obeyed is within the imaging range H of the front camera 2 in order to recognize the traffic light S3 to be obeyed, and the blind spot Q of the oncoming right-turning vehicle B is reduced. The stop position and orientation of the vehicle A are determined so as to ensure the recognition of the oncoming straight-ahead vehicle C by the front camera 2.

Subsequently, the ECU 10 determines whether or not the stop position of the vehicle A deviates from the farthest stop position by a specified amount or more (step S118). At this time, it is determined whether or not the stop position of the vehicle A is separated from the farthest point of the stop position by a specified distance (for example, 2 m in the longitudinal direction of the vehicle A and 0.5 m in the width direction of the vehicle A) or more. Further, the deviation amount of the orientation of the vehicle A with respect to the extending direction of the lane in which the vehicle A is traveling may also be determined.

When the ECU 10 determines that the stop position of the vehicle A deviates from the farthest point of the stop position by a specified amount or more, the ECU 10 displays an image including a traffic signal to be complied with at least based on the image captured by the front camera 2. The display 7 is controlled so as to do so (step S119).

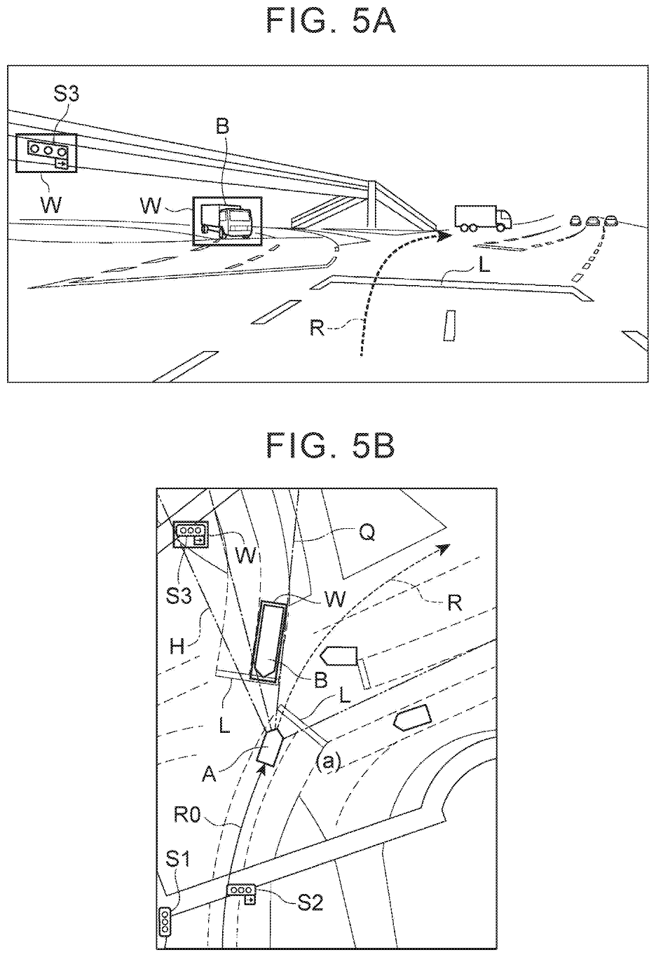

For example, at the intersection shown in FIG. 4, an image in front of the vehicle A captured by the front camera 2 is displayed on the display 7 in Augmented Reality (AR) as shown in FIG. 5A.

Specifically, the traffic light S3 and the oncoming right-turning vehicle B to be obeyed in the display image of the display 7 are highlighted by, for example, a rectangular frame W or highlighted. Therefore, the driver of the vehicle A can immediately know the positions of the traffic light S3 and the oncoming right-turning vehicle B, which are to be obeyed. In addition, since the traffic light S3 to be obeyed is positioned at the left end of the display image, the driver can easily notice the reason why the vehicle A is stopped at a position before the farthest stop position. Further, in the display image of the display 7, the course R along which the vehicle A is to travel is displayed with a dashed arrow. Therefore, the driver can intuitively understand the future course R of the vehicle A.

Further, as shown in FIG. 5B, a bird's-eye view image obtained by synthesizing the captured images of the front camera 2, the rear camera 3, and the side camera 4 maybe displayed on the display 7 as a panoramic view monitor. A bird's-eye view image is an image of the vehicle A viewed from directly above.

The panoramic view monitor displays a bird's-eye view image together with the imaging range H of the front camera 2. On the panoramic view monitor, the obeying traffic light S3 and the oncoming right-turning vehicle B are highlighted, similar to the image shown in FIG. 5A. In the panoramic view monitor, the range blocked by the oncoming right-turning vehicle B (blind spot Q) is also displayed on the display 7. The driver of the vehicle A stops at a position before the farthest stop position because the traffic light S3 to be obeyed is located at the left end of the imaging range H of the front camera 2. It becomes easier to understand why.

Further, on the panoramic view monitor, the course R0 traveled by the vehicle A is displayed with a solid line arrow, and the course R along which the vehicle A is scheduled to travel is displayed with a broken line arrow. Therefore, the driver can intuitively understand the future course R of the vehicle A.

Returning to FIG. 3, after executing step S119 or when determining in step S118 that the stop position of the vehicle A is not deviated from the farthest point of the stop position by a specified amount or more, the ECU 10 turns on the front camera 2. After recognizing from the captured image that the traffic light to be obeyed is green, the acceleration/deceleration control device 5 and the steering control device 6 are controlled so that the vehicle A travels along the travel locus (step S120).

Subsequently, the ECU 10 determines whether there is an obstacle entering the course of the vehicle A based on the image captured by the front camera 2 (step S121). When the ECU 10 determines that there is an obstacle entering the course of the vehicle A, the ECU 10 controls the acceleration/deceleration control device 5 so that the vehicle A temporarily stops (step S122). Then, the ECU 10 executes the above step S121 again.

When the ECU 10 determines that there is no obstacle entering the course of the vehicle A, it controls the acceleration/deceleration control device 5 and the steering control device 6 so that the vehicle A turns right and passes through the intersection (step S106).

In the above, the determination unit 11 executes the above steps S102, S105, S116, and S121. The traffic signal identification unit 12 executes the above steps S101, S107, and S108. The travel control unit 13 executes the above procedures S103, S104, S106, S115, S117, S120, and S122. The stop position furthest point determination unit 14 executes the above steps S109 to S111. The stop position determination unit 15 executes the above steps S112 and S113. The travel locus setting unit 16 executes the above step S114. The display control unit 17 executes the above steps S118 and S119.

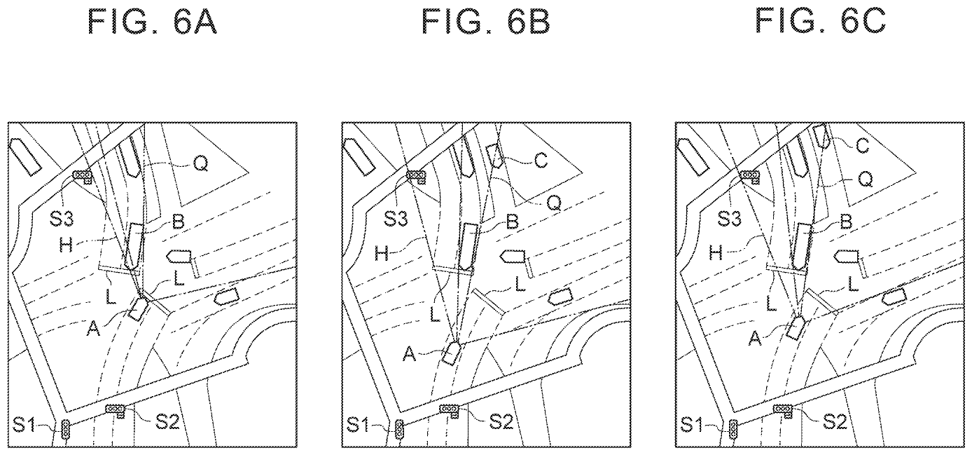

By the way, when the vehicle A turns right at the intersection manually by the driver, the vehicle A is stopped at the stop position reference line L when waiting for the right turn in the intersection as shown in FIG. 6A. In this case, the driver can confirm the traffic light S3 to be obeyed by changing his posture.

On the other hand, when self-vehicle A turns right at an intersection due to automatic driving, if self-vehicle A is stopped at stop position reference line L, traffic light S3 to be obeyed does not fit within imaging range H of front camera 2. For this reason, as shown in FIGS. 6B and 6C, by stopping the vehicle A in front of the stop position reference line L so that the traffic light S3 to be obeyed falls within the imaging range H of the front camera 2, the front camera 2 can recognize the traffic light S3 to be obeyed. In addition, in FIG. 6B, the vehicle A is stopped at a position straight back from the stop position reference line L. In FIG. 6C, the vehicle A is stopped at a position retreated from the stop position reference line L along the right turn lane.

However, simply adjusting the stop position of the vehicle A in the longitudinal direction of the vehicle A with respect to the stop position reference line L in order to recognize by the front camera 2 the traffic light S3 to be observed may result in the stop position of the vehicle A deviating greatly from the stop position reference line L. After the oncoming straight-ahead vehicle C has passed, the vehicle A can turn right. In order to recognize the oncoming straight-ahead vehicle C by reducing the blind spot Q of the oncoming right-turning vehicle B, it is necessary to consider not only the position of the longitudinal direction of the vehicle A but also the orientation of the vehicle A. However, if the stop position and direction of the vehicle A are different from those during manual driving, the driver of the vehicle A may feel uncomfortable.

To address such a problem, in the present embodiment, the front camera 2 captures an image of the front of the vehicle A. Based on the captured image, the traffic signal installed at the intersection to be obeyed is specified. Then, when the indication content of the traffic signal to be obeyed is a state in which a right turn is permitted, the traffic signal to be obeyed is within the imaging range of the front camera 2 in front of the farthest point of the stop position for waiting for a right turn in the intersection. A suitable stop position is determined. The vehicle A is controlled to travel to the stop position. Then, when the vehicle A stops at the stop position, the display 7 displays an image including at least the traffic signal recognized by the front camera 2 to be obeyed. Therefore, when the vehicle A, which drives on the left side, turns right at the intersection, even if the vehicle A stops at a position before the farthest stop position where the vehicle A should be stopped during manual operation to wait for the right turn, the vehicle A can The driver can see the image displayed on the display 7 and understand the reason why the vehicle A stopped at a position in front of the farthest stop position. This suppresses the driver of the vehicle A from feeling uncomfortable with the stop position and orientation of the vehicle A when the vehicle A stops in the intersection when turning right.

In addition, in the present embodiment, the traffic lights to be complied with are highlighted on the display 7. Therefore, the driver can immediately understand the reason why the vehicle A has stopped at a position before the farthest stop position. Therefore, this further suppresses the driver from feeling uncomfortable.

Further, in the present embodiment, an image in front of the vehicle A captured by the front camera 2 is displayed on the display 7, thereby allowing the process of displaying an image including a traffic signal to be obeyed on the display 7 to be simplified. At this time, for example, if the traffic signal subject to compliance is captured at the end of the image, the driver must move the vehicle A to the farthest stop position so that the traffic signal subject to compliance is within the imaging range of the front camera 2. It can be easily recognized that it has stopped at a position closer to the front.

Further, in this embodiment, a bird's-eye view image obtained by synthesizing the captured images of the front camera 2, the rear camera 3, and the side camera 4 is displayed on the display 7 together with the imaging range of the front camera 2, so that the driver can immediately know that the traffic light to be obeyed is within the imaging range of the front camera 2. At this time, for example, when the traffic signal to be obeyed is captured at the end of the imaging range of the front camera 2, the driver must move the vehicle to keep the traffic signal to be obeyed within the imaging range of the front camera 2. It can be easily recognized that A has stopped at a position before the farthest point of the stop position.

Further, in this embodiment, when the stop position of the vehicle A deviates from the farthest point of the stop position by a specified amount or more, an image including a traffic signal to be observed is displayed on the display 7. Therefore, when the stop position of the vehicle A is close to the farthest point of the stop position, it is not necessary to display the image including the traffic signal to be observed on the display 7, so that the driving support processing by the ECU 10 can be simplified.

Further, in this embodiment, even if the driver loses track of the traffic signal to be observed after the vehicle A enters the intersection, the driver can confirm the traffic signal to be observed by looking at the display 7. In addition, since the route along which the vehicle A is scheduled to travel is displayed on the display 7, the behavior of the vehicle A and the future predicted route can be intuitively confirmed.

In addition, this disclosure is not limited to the said embodiment. For example, in the above-described embodiment, the rear camera 3 and the side camera 4 are mounted on the vehicle A. However, as shown in FIG. 5A, when the images taken by the front camera 2 is displayed on the display 7, the rear camera 3 and side camera 4 maybe omitted

Further, in the above-described embodiment, when the stop position of the vehicle A deviates from the farthest point of the stop position by a specified amount or more, the image including the traffic signal to be observed is displayed on the display 7. However, the mode is not limited to this. Regardless of the stop position of the vehicle A, the display 7 may display an image including the traffic signal to be observed.

Further, the above-described embodiment is a device that assists the driving of a left-hand vehicle when it turns right at an intersection, but the present disclosure is not particularly limited to this form. In countries or regions where vehicles drive on the right side, the present disclosure can also be applied to a device that assists the driving of a vehicle when the vehicle turns left at an intersection. In this case, when the display content of the traffic signal to be obeyed indicates that a left turn is permitted, the obeying target is placed within the imaging range of the front camera 2 before the farthest point of the stop position for waiting to turn left in the intersection. The stop position is determined so that the traffic light of Then, when the vehicle A stops at the stop position to wait for a left turn, the display 7 displays an image including at least the traffic signal recognized by the front camera 2 to be obeyed.

What is claimed is:

1. A driving support device that supports driving of a vehicle for left-hand traffic when the vehicle turns right at an intersection, the driving support device comprising:
a display unit that displays information related to driving support of the vehicle;
a front imaging unit that takes an image of an area in front of the vehicle;
a traffic light identifying unit that identifies, based on the image taken by the front imaging unit, a traffic light to be obeyed and installed at the intersection;
a stop position determination unit that determines a stop position such that, when a content of an aspect of the traffic light to be obeyed and identified by the traffic light identifying unit indicates a state in which a right turn is permitted, the traffic light to be obeyed fits within an imaging range of the front imaging unit at an area before a stop position farthest point for waiting for the right turn in the intersection;
a travel control unit that controls the vehicle to travel to the stop position determined by the stop position determination unit; and
a display control unit that causes the display unit to display, when the vehicle stops at the stop position, an image including at least the traffic light to be obeyed and recognized by the front imaging unit.

2. The driving support device according to claim 1, wherein the display control unit causes the display unit to highlight the traffic light to be obeyed.

3. The driving support device according to claim 1, wherein the display control unit causes the display unit to display the image of the area in front of the vehicle, the image being taken and obtained by the front imaging unit.

4. The driving support device according to claim 1 further comprising:
a rear imaging unit that takes an image of an area behind the vehicle; and
a side imaging unit that takes an image of an area on a lateral side of the vehicle, wherein the display control unit causes the display unit to display a bird's-eye view image together with the imaging range of the front imaging unit, the bird's-eye view image being obtained by synthesizing the images taken by the front imaging unit, the rear imaging unit, and the side imaging unit.

5. A driving support device that supports driving of a vehicle for right-hand traffic when the vehicle turns left at an intersection, the driving support device comprising:
a display unit that displays information related to driving support of the vehicle;
a front imaging unit that takes an image of an area in front of the vehicle;
a traffic light identifying unit that identifies, based on the image taken by the front imaging unit, a traffic light to be obeyed and installed at the intersection;
a stop position determination unit that determines a stop position such that, when a content of an aspect of the traffic light to be obeyed and identified by the traffic light identifying unit indicates a state in which a left turn is permitted, the traffic light to be obeyed fits within an imaging range of the front imaging unit at an area before a stop position farthest point for waiting for the left turn in the intersection;
a travel control unit that controls the vehicle to travel to the stop position determined by the stop position determination unit; and
a display control unit that causes the display unit to display, when the vehicle stops at the stop position, an image including at least the traffic light to be obeyed and recognized by the front imaging unit.
